(19) United States
(12) Patent Application Publication
(10) Pub. No.: US 2010/0127026 A1
(43) Pub. Date: May 27, 2010

(54) LOCKDOWN SOFT ROOFRACK

(75) Inventor: Alastair Rhodes, Auckland (NZ)

Correspondence Address: BROOKS KUSHMAN P.C., 1000 TOWN CENTER, TWENTY-SECOND FLOOR, SOUTHFIELD, MI, 48075, US

(73) Assignee: CURVE INTERNATIONAL LIMITED, Auckland (NZ)

(21) Appl. No.: 11/994,888

(22) PCT Filed: Jul. 4, 2006
(86) PCT No.: PCT/NZ06/00170

§ 371 Date: Jan. 7, 2008

(30) Foreign Application Priority Data
Jul. 5, 2005 (NZ) 541114

(51) Int. Cl. B60R 9/048; B60R 9/08

(52) U.S. Cl. 224/318; 224/324

(57) ABSTRACT

The lockdown soft roofrack provides a platform in particular a ‘roofrack’ that allows the carriage of sports boards on top of a variety of vehicle's roofs in a convenient and secure fashion. The invention contains three items, of which one item is a piece of webbing, the second item is a tightening mechanism and the third item is a detachable load hook. When the webbing is tightened via the single tightening mechanism it pulls through both ends of the detachable load hook thus tightening a loop of the webbing around the sports boards whilst simultaneously tightening the webbing around the vehicle's roof, thus pulling the sports boards securely down onto a vehicles roof.

### TECHNICAL FIELD

The present invention relates to an improved roofrack, more particularly what is commonly referred to a ‘soft’ roofrack for carrying ‘sports boards’ including surf boards, windsurfers, kayak's and the like on the top of motor vehicles.

### BACKGROUND ART

Sports enthusiasts, such as surfers, generally transport their boards on top of vehicle's roofs to provide additional storage space within their car, or because their boards will not fit within their car.

The boards are usually tied onto a typical ‘roofrack’ that comprises two parallel metal bars extending across the vehicles roof. These roofracks are permanently or semi-permanently secured to the roof of the vehicle, and as such are difficult to transfer from vehicle to vehicle.

There are also a number of ‘soft’ roofracks on the market, which generally consist of a number of webbing straps that secure the roofrack to the motor vehicle and that also secure the sports boards to the roofrack. These soft roofracks are non permanent and so allow the roofracks to be easily transferred from vehicle to vehicle and also mean that the roofrack can be packed down for ease of travel, however they do not have the advantages or functions of the present invention.

The major disadvantages of the present soft roofracks (which this invention overcomes) include:
They generally consist of more than one webbing strap, which results in weak points where the webbing straps connect to each other, and also means the straps require two tightening points. Having two tightening points increases the amount of time taken to set up the roofrack and complicates the set up process. The second strap can also vibrate from the windflow caused by a moving vehicle causing damage to vehicles paint work.
They generally consist of a webbing loop that runs inside the car and another webbing loop attached to the first loop (to hold the sports boards onto the first loop). Having two loops means that the webbing does not pull from the top of the sports board directly down onto the roof of the car, which lessons the force that can be applied to pull the sports boards onto the roof of the vehicle, which means that there is increased chance of movement and vibrations of the sports boards. This may result in damage to the vehicles roof or the sports boards.
They generally are only designed to attach in a single way, ie either by looping the webbing through the car doors, or by attaching to gutter hooks. None have been designed to work with the existing loadbars attached to some motor vehicles.

In view of the foregoing, there exists the need for an easy to use, mobile and secure ‘soft’ roofrack, which can be used in a variety of ways to transport sports boards on top of a motor vehicle.

### DISCLOSURE OF INVENTION

The objective of the invention is to provide a platform in particular a ‘roofrack’ that will allow the carriage of sports boards on top of a variety of vehicle's roofs in a convenient and secure fashion which will go at least some way towards avoiding or minimising the above disadvantages.

### BRIEF DESCRIPTION OF DRAWINGS AND BEST MODE FOR CARRYING OUT THE INVENTION

One preferred form of the invention will now be described with reference to the accompanying drawings, of which:

FIG. 1 shows the invention including the detachable load hook, the single piece of webbing and the single tightening mechanism (the ‘camlock’).

FIG. 2 shows a detailed view of the ‘detachable load hook’ and the single piece of webbing running through this hook.

FIG. 3 shows how the invention can be attached via the ‘thru doors’ attachment method and how the tightening mechanism tightens the webbing around the sports boards and also pulls the boards down onto the roof of the motor vehicle.

FIG. 4 shows how the invention can be attached via the ‘thru loadbars’ attachment method and how the tightening mechanism tightens the webbing around the sports boards and through the vehicles load bars (if it has them) which pulls the boards down onto the roof of the motor vehicle.

FIG. 5 shows how the invention can be attached via the ‘gutter clips’ attachment method and how the tightening mechanism tightens the webbing around the sports boards attaching to the vehicles gutters (if it has them) via a set of 2× gutter clips per rack which pull the boards down onto the roof of the motor vehicle.

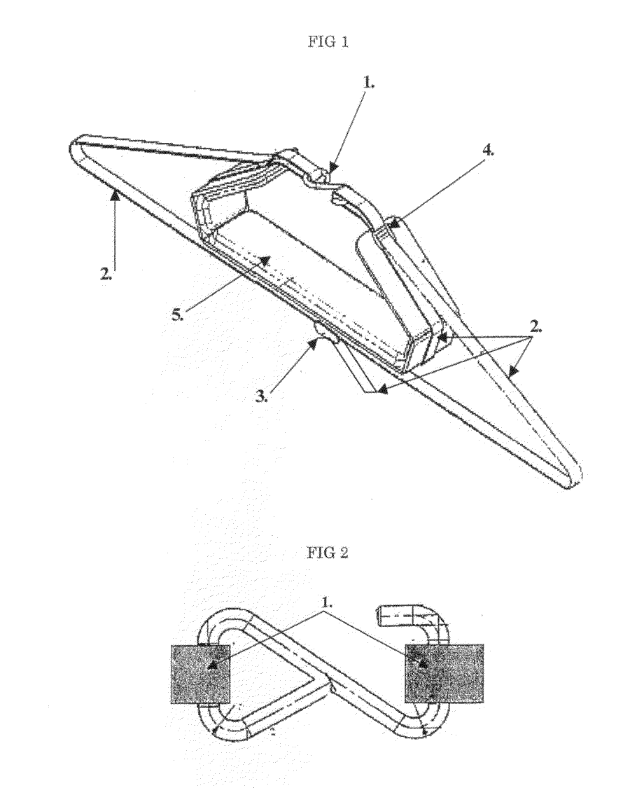

In the form shown, there is provided a roofrack for a vehicle which consists of a number of different components, namely:
A detachable load connector (in this case a hook) FIG. 1(1), preferable made of metal although other suitable strong materials such as plastics may be used.
A single piece of strap (in this case a webbing strap) FIG. 1 (2), which may or may not have padding attached to it.
A tightening mechanism, in this case a camlock FIG. 1 (3), preferable made of metal although other suitable materials such as plastics may be used.
A tri-glide FIG. 1(4), preferable made of metal although other suitable materials such as plastics may be used.
Padding FIG. 1(5) to protect the sports boards (this is optional).

The detachable load hook in its preferred embodiment is open at one end FIG. 2 which allows, when the tension on the webbing FIG. 2(1) is released, to release the webbing from the load hook so that the sports boards can be easily removed without undoing the webbing from the camlock. This allows easy and convenient access to the sports boards.

The invention consists of a single piece of webbing FIG. 1(2) which runs around the sports boards and then through both sides of the detachable load hook FIG. 1(1) and then doubles back on itself prior to being directed through the tri-glides FIG. 1(4). The webbing then runs either through the vehicles doors, through the vehicle load bars on through the gutter clips attached to the vehicle gutters and is tightened via the camlock to form a ‘single webbing loop’.

The invention contains a camlock FIG. 1(3) attached to one end of the webbing which creates a single tightening point which when the webbing is pulled through the camlock it tightens the webbing around the sports boards and around the roof of the vehicle, creating a very secure load with minimal movement. The tension on the webbing can be released by depressing the camlock's lever spring. By tightening the webbing strap that runs through the camlock the webbing pulls the boards down onto the car roof, which minimises movement of the sports boards. This reduces any rolling, lifting or sliding of the boards on the roof, meaning less friction on the roof and a more secure load.

The invention also contains a tri-glide FIG. 1(4) that helps to guide the webbing back onto itself and allows for adjustment of the length of strap FIG. 1(5).

The invention can also be reconfigured by attaching/detaching two gutter clips to each rack FIG. 5(1). These gutter clips are preferably made of metal although other suitable strong materials such as plastics may be used. They contain gaps for the webbing to run through which when the webbing is tightened pulls the gutter clips against the gutters of the motor vehicles and thus provides a connection to the vehicle.

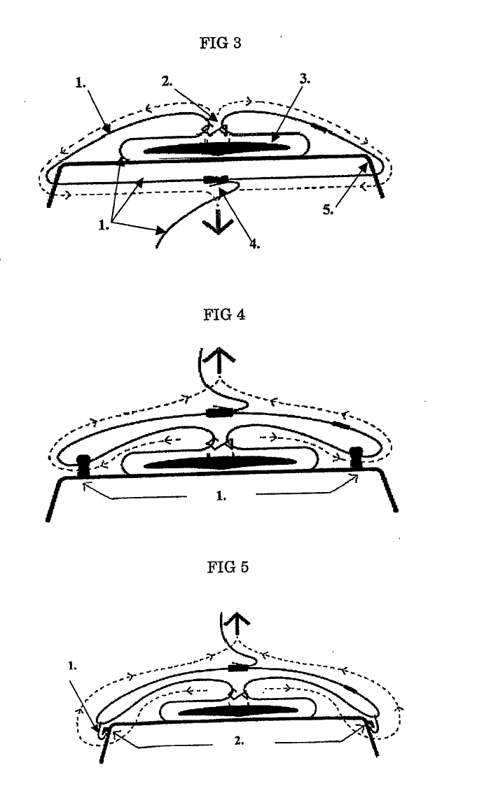

With the addition of two gutter: clips per rack described above, the invention has 3 connection methods, these are:
Thru doors where the webbing FIG. 3 (1) runs through load hook FIG. 3 (2) and tightens around the sportsboards FIG. 3(3) via the camlock FIG. 3(4) and also tightens around the vehicles roof by running through the open doors of the motor vehicle FIG. 3(5) which attaches the invention to the motor vehicle.
Thru load bars where the webbing runs through a vehicles load bars FIG. 4 (1) (metal bars or rails permanently attached to the long sides of some vehicles roofs) in order to attach the invention to the motor vehicle
Via gutter clips where two gutter clips FIG. 5(1) can be attached to the webbing and where the gutter clips attach to the gutters of vehicle FIG. 5(2) in order to attach the invention to the motor vehicle.

It will be appreciated that the invention broadly consists of the parts, elements and features described in this specification, and is deemed to include any equivalents know in the art which, if substituted for the described integers, would not alter the substance of the invention.

What we claim is:

1. A set of components comprising at least three items, of which one item is a single piece of webbing, the second item is a tightening mechanism and the third item is a detachable load hook. When the webbing is tightened via the tightening mechanism it pulls through both ends of the detachable load hook thus tightening a loop of the webbing around the sports boards whilst simultaneously pulling the sports boards down onto a vehicles roof.

2. A set of components as claimed in claim 1, wherein the detachable load hook contains one open end to allow the webbing loop to be released and the sports boards to be accessed via this detachable load hook without having to release the webbing entirely from the tightening mechanism.

3. A set of components as claimed in claim 1 or claim 2, which can be configured to allow three different connection methods to attach the roofrack and consequently the sports boards to a vehicles roof. These attachment methods are: through the doors of a vehicle, through the loadbars of a vehicle or through connection to a vehicles gutters. All three methods ensure that when the webbing is tightened via the tightening mechanism it pulls through both ends of the detachable load hook thus tightening a loop of the webbing around the sports boards whilst simultaneously pulling the sports boards down onto a vehicles roof, thus ensuring the sports boards are securely fastened onto the vehicles roof.

4. A set of roofrack components as claimed in any proceeding claim where there are seven different components.

5. A set of single roofrack components as claimed in claim 4, in which the items are a single piece of webbing, a detachable load hook, two detachable gutter clips, two tri-glides and a tightening mechanism (in this case a camlock).

6. A set of components that form a roofrack substantially as described and as illustrated in the accompanying drawings.
